(19) United States
(12) Patent Application Publication
(10) Pub. No.: US 2024/0288022 A1
(43) Pub. Date: Aug. 29, 2024

(54) SHELVING UNIT

(71) Applicant: EAGLE INDUSTRIAL GROUP INC., Rancho Santa Margarita, CA (US)

(72) Inventors: Matthew Eaton Davis, Rancho Santa Margarita, CA (US); Jeff W. KUECKER, Lake Forest, CA (US); Dylan T. RITCHIE, Carlsbad, CA (US); Noah Michael Rodebaugh, Lake Forest, CA (US)

(73) Assignee: EAGLE INDUSTRIAL GROUP INC., Rancho Santa Margarita, CA (US)

(21) Appl. No.: 18/652,570

(22) Filed: May 1, 2024

Related U.S. Application Data
(63) Continuation-in-part of application No. 29/940,186, filed on Apr. 30, 2024.
(63) Continuation-in-part of application No. 16/259,149, filed on Jan. 28, 2019, now Pat. No. 11,992,120.
Application No. 16/259,149 is a continuation of application No. 29/637,331, filed on Feb. 15, 2018, now abandoned.
(60) Provisional application No. 62/660,928, filed on Apr. 20, 2018.

(51) Int. Cl. F16B 35/06; F16B 5/02

(52) U.S. Cl. CPC F16B 35/06; F16B 5/0208

(57) ABSTRACT

An adjustable free-standing shelving unit with horizontal shelf support beams suitable for holding one or more wire deck panels, which are detachably mounted to vertical corner posts by way of a unique combination of shoulder bolts, attached to the horizontal support beams, and keyhole slots in the vertical corner posts. In some embodiments, shoulder bolts having a head with a wrench receiving surface, an unthreaded shoulder, and a threaded shank are attached to the horizontal support beams using hex nuts. The keyhole slots, which are formed in each of the angled flat sides of the L-shaped vertical corner posts, are sized so that the heads of the shoulder bolts maybe inserted into the wide upper openings of the keyhole and then pushed downwardly so that the unthreaded shoulders of the bolts will slide into the low slots.

### CROSS-REFERENCE TO RELATED APPLICATIONS

This application is a Continuation-in-Part and claims the benefit of U.S. application Ser. No. 16/259,149, titled “Shelving Unit,” filed by Mathew Davis, et al., on Jan. 28, 2019, which application both claims priority from U.S. Provisional Patent Application No. 62/660,928, entitled “Shelving Unit” and filed on Apr. 20, 2018 by Matthew E. Davis, et al., and is Continuation of and claims priority from U.S. patent application Ser. No. 29/637,331 entitled “Shelving Unit” and filed Feb. 15, 2018 by Matthew E. Davis, et al.

This application is a Continuation-in-Part and claims the benefit of U.S. Application Ser. No. 29/940, 186, titled “Carriage Nut” and filed by Noah Michael Rodebaugh, et al. on Apr. 30, 2024.

This application incorporates the entire contents of the foregoing applications herein by reference.

### TECHNICAL FIELD

Various embodiments relate generally to shelving units used for storage, and more particularly to storage racks that may be easily assembled but that are also strong and secure enough for commercial use or for heavy-duty consumer applications.

### BACKGROUND

Adjustable steel shelving units are widely used in homes and offices for consumer purposes and for commercial and industrial applications. The typical shelving system includes a set of four corner posts which stand vertically upright. Shelf support beams are connected horizontally between each adjacent pair of vertical corner posts to form rectangular frames at varying heights. Each of the shelf frames may support a flat shelf or deck on which various items maybe supported and stored.

Many prior art shelving systems require the use of bolts or other fasteners to directly attach the support beams to the vertical posts. Typically, the bolts are inserted through corresponding holes in the support beams and in the vertical posts and secured by washers and nuts on the inward facing sides of the vertical posts. Such systems may be difficult and time-consuming to assemble, particularly for one person, because the beams and frames must be held in the proper location while the fasteners are inserted.

Other prior art systems, often referred to as “boltless” systems, use integrally formed rivets or studs on the ends of the support beams. Each of the integrally formed rivets will have a wide head portion attached to the support beam by a narrower shank portion. The vertical posts are formed with vertically spaced keyhole-shaped slots, each slot having a wider upper portion to allow the rivet head to pass through and a lower narrow portion that is wide enough for the rivet shank, but which is not wide enough for the rivet head to pass through. Boltless systems are considered to be easier to assemble and disassemble than shelving systems using separate fasteners or bolts, however such systems also suffer from a number of disadvantages. In order to form a tight fit, the width of the shank must be virtually the same as the thickness of the vertical post. This means that the rivets typically have to be hammered down into place, which makes assembly and disassembly more difficult. And even with such a tight fit, the use of rivets and slots does not hold the shelves in place as securely as the use of separate fasteners that maybe tightened even further.

Also, manufacturing variations make it much more difficult to reliably form rivets capable of supporting very heavy loads, while the strength and load supporting capabilities of separate bolts or fasteners are more uniform and more easily calculated.

### SUMMARY

Embodiments are directed to an adjustable free-standing shelving unit that is easy to assemble, while still being strong and secure enough for commercial use or for heavy-duty consumer applications. The shelving unit has horizontal shelf support beams, which are suitable for holding one or more wire deck panels, and which are mounted to the vertical corner posts of the shelving unit by way of a unique combination of shoulder bolts, attached to the horizontal support beams, and keyhole slots in the vertical corner posts. The combination of shoulder bolts and keyhole slots provides the advantages in load capacity and installation strength of the prior art systems using separate fasteners, while providing an ease of installation that is comparable to boltless shelving units.

### BRIEF DESCRIPTION OF THE DRAWINGS

FIG. 1 is a perspective view of a shelving unit.

FIG. 2 is an enlarged view of a portion of FIG. 1 as indicated in the broken line circle in FIG. 1.

FIG. 3 is an exploded view of the embodiment of FIG. 1.

FIG. 4 is an enlarged view of a portion of FIG. 3 as indicated in the broken line circle in FIG. 3.

FIG. 5A is a perspective view of a shoulder bolt which may be used to mount the horizontal shelf support beams by way of the keyhole slots in the vertical posts according to an embodiment.

FIG. 5B is a side view of a shoulder bolt and hex nut according to an embodiment.

FIGS. 6A-6B show another embodiment of a shoulder bolt and nut used to attach a support beam to a vertical support according to an embodiment.

FIG. 7A is a perspective view of a vertical post in an embodiment.

FIG. 7B is an enlarged view of the portion of a vertical post as indicated by the broken line circle in FIG. 7A, showing the key-hole shaped slots in the vertical support.

FIG. 8A is a perspective view of a longitudinal support beam according to an embodiment.

FIG. 8B is a perspective view of a transverse support beam according to an embodiment.

FIG. 8C is a cross sectional view of a support beam according to an embodiment.

FIG. 9A is a perspective view of a center support beam according to an embodiment.

FIG. 9B is a side view of a center support beam according to an embodiment.

FIG. 10 is a view of a clip used to hold two deck panels in place on the support beams according to an embodiment.

FIG. 11 depicts a domed-shaped carriage nut.

FIG. 12 depicts front view of a domed-shaped carriage nut used in a shelving unit.

FIG. 13 depicts a rear view of a domed-shaped carriage nut used in a shelving unit.

FIG. 14 depicts a front and rear perspective view of an exemplary dome-shaped carriage nut.

FIG. 15 depicts a rear view of an exemplary dome-shaped carriage nut.

FIG. 16 depicts a side view of an exemplary dome-shaped carriage nut.

FIG. 17 depicts a top view and a bottom view of an exemplary dome shaped carriage nut.

FIG. 18 depicts an exemplary shelving including a double keyhole & dome shaped carriage nut configuration.

Like reference symbols in the various drawings indicate like elements.

### DETAILED DESCRIPTION OF ILLUSTRATIVE EMBODIMENTS

Embodiments are directed to an adjustable free-standing shelving unit that is easy to assemble, while still being strong and secure enough for commercial use or for heavy-duty consumer applications. The shelving unit has horizontal shelf support beams, which are suitable for holding one or more wire deck panels, and which are detachably mounted to the vertical corner posts of the shelving unit by way of a unique combination of shoulder bolts, attached to the horizontal support beams, and keyhole slots in the vertical corner posts. In some embodiments, shoulder bolts having a head with a wrench receiving surface, an unthreaded shoulder, and a threaded shank are attached to the horizontal support beams using hex nuts. The keyhole slots, which are formed in each of the angled flat sides of the L-shaped vertical corner posts, are sized so that the heads of the shoulder bolts maybe inserted into the wide upper openings of the keyhole and then pushed downwardly so that the unthreaded shoulders of the bolts will slide into the low slots.

Significantly, once the horizontal beams have been mounted onto the vertical posts in this fashion, the heads of the shoulder bolts maybe further tightened using their wrench receiving surfaces to securely hold the horizontal beams in place by way of compressive force applied to the vertical supports. A shelving unit according to embodiments thus provides the ease of assembly of a typical boltless shelving system, while also proving the increased strength and security of a bolted shelving system.

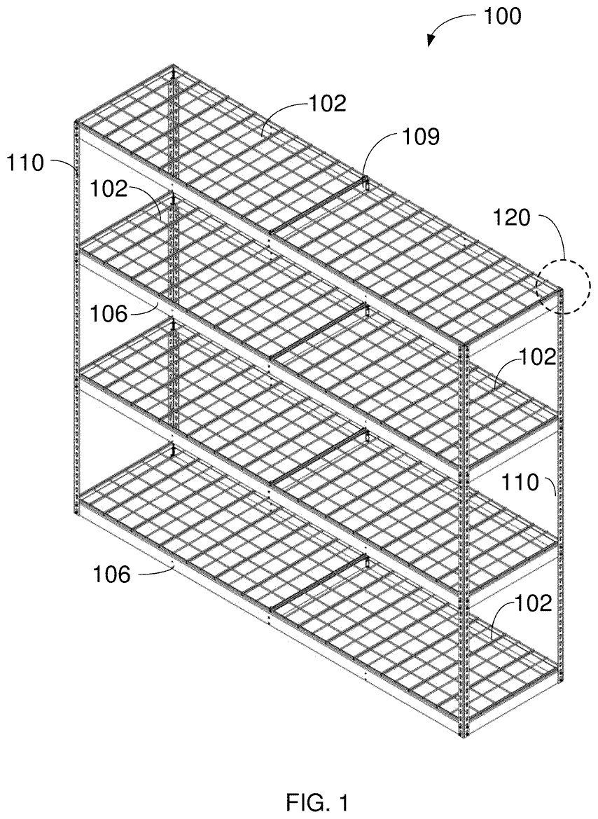

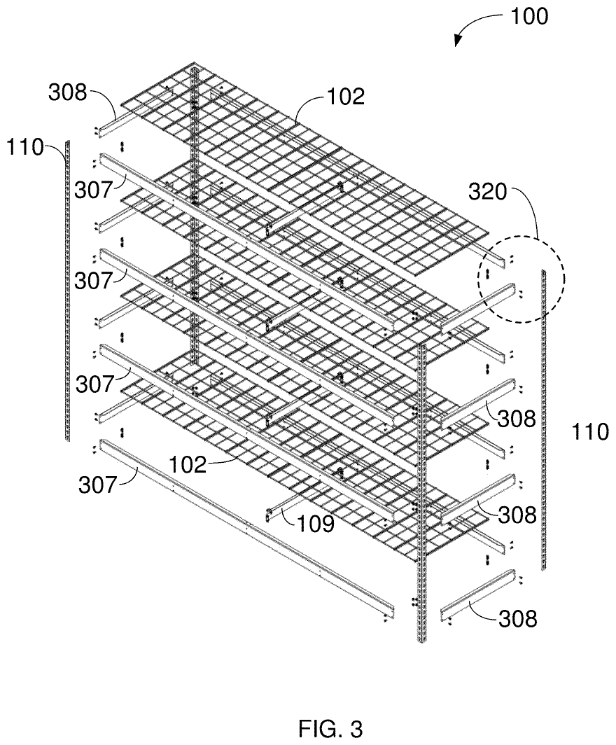

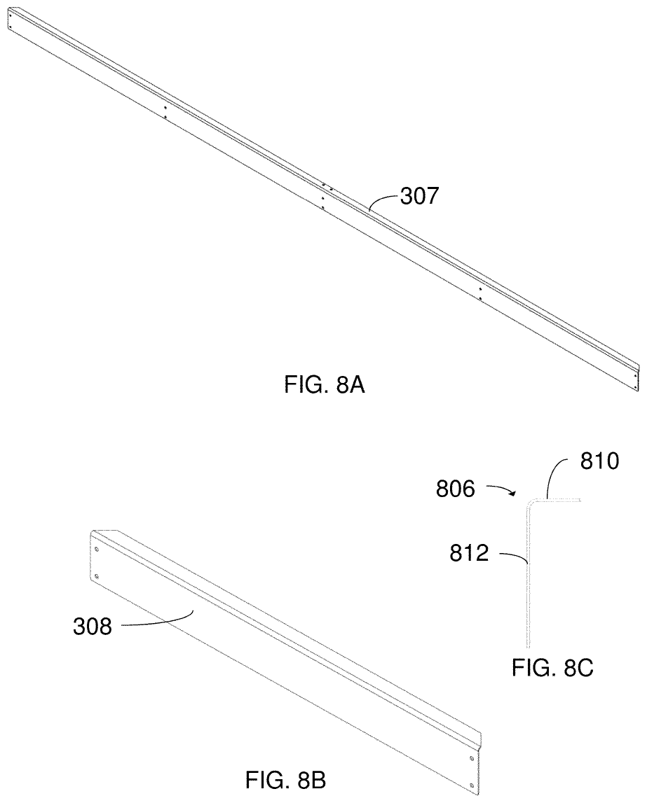

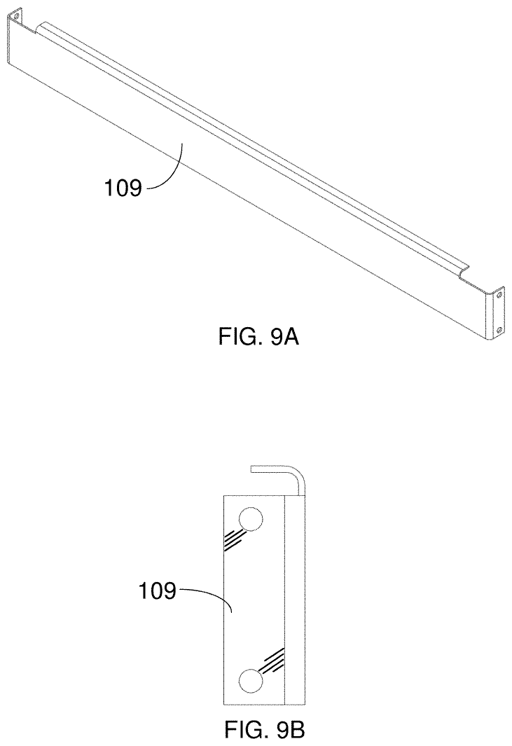

Turning now to the drawings, FIG. 1 shows a shelving unit or apparatus 100 according to an embodiment including a plurality of vertically spaced shelves or decks 102, which maybe, for example, a welded wire mesh, as shown, or a solid sheet, such as plywood, metal, or plastic. FIG. 3 is an exploded view of the shelving assembly of FIG. 1. In some embodiments, decks maybe formed from two or more deck panels mounted side-by-side. Referring also to FIG. 3, decks 102 are supported by beams 106 that form a rectangular frame using four beams 106, two longitudinal beams 307 (a front beam and a back beam) and two transverse side beams 308. Referring also to FIGS. 8A-C, in some embodiments, the beams forming the frame have a generally L-shaped cross section 806 with a vertical portion 812, which provides the mounting surface for the threaded shoulder bolts described below, and a horizontal portion 810 (which supports the deck) as shown in FIG. 8C. One or more center support beams 109 may be used to provide additional support for deck 102.

In some embodiments the center support may, for example, provide additional support to the deck. The center supports may, for example, prevent twisting or tortional stresses in the long cross beams. For example, as the cross beams are loaded, the beam may, for example, have a tendency to twist inward. The center support may, for example, resist the twisting to increase the loading capacity.

Beams maybe formed from steel or any other appropriate material, with a thickness of at least 20 gauge, such as at least 16 gauge, at least 12 gauge or at least 10 gauge bent to form a member having a generally L-shaped cross-section using conventional machinery.

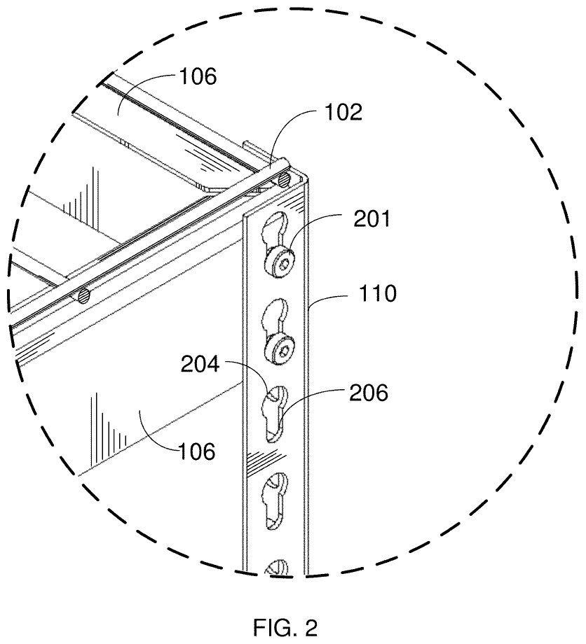

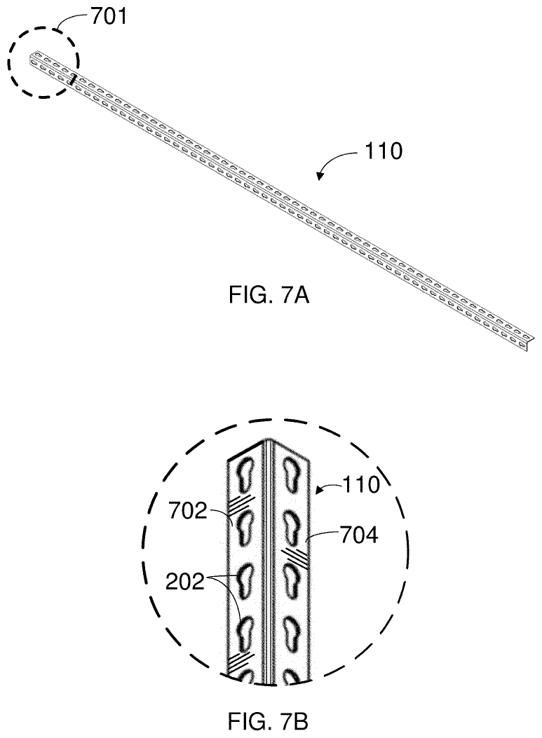

Beams 106 are attached to and supported by vertical posts 110 (as described in more detail below) at each corner of deck 102, as shown in FIG. 2 which is an enlarged view of the portion of FIG. 1 indicated by the broken line 120. Referring also to FIGS. 7A and 7B, in some embodiments, the vertical posts 110 are generally L-shaped having two flat sides 702, 704 of approximately equal width that lie perpendicular to one another, with each face including a plurality of spaced holes so that the shelves maybe position at any desired height. As shown in greater detail in FIG. 7B, which is an enlarged view of the portion of FIG. 7A indicated by the broken line 701, the spaced holes in the vertical posts maybe generally shaped in the manner of a keyhole with a wider upper portion 204 and a lower narrow portion 206. As described below, the keyhole-shaped openings should be sized so that the upper portion is large enough to receive the head portion of a shoulder bolt or similar fastener, while the lower narrow portion extending downward is sufficiently wide to receive the shank of the shoulder bolt or similar fastener but not large enough to allow passage of the head.

Vertical posts maybe formed from steel or another appropriate material with a thickness of at least 20 gauge, such as at least 16 gauge, at least 12 gauge or at least 10 gauge. Although the vertical posts of FIG. 1 have an L-shaped cross section, vertical posts with a different cross-section shape maybe used, for example a flat or rectangular cross-section. Further, vertical posts maybe located at locations other than the corners of deck 102 as long as the deck is adequately supported. In some embodiments, each vertical post has at least an upper post member and a lower post member coupled together to form a longer vertical post. The overall height of vertical post 110 may then be controlled by adjusting the overlap of the upper and lower post members, which maybe connected using bolts, or other means, such as interlocking slots on one post member and protrusions on the other post member.

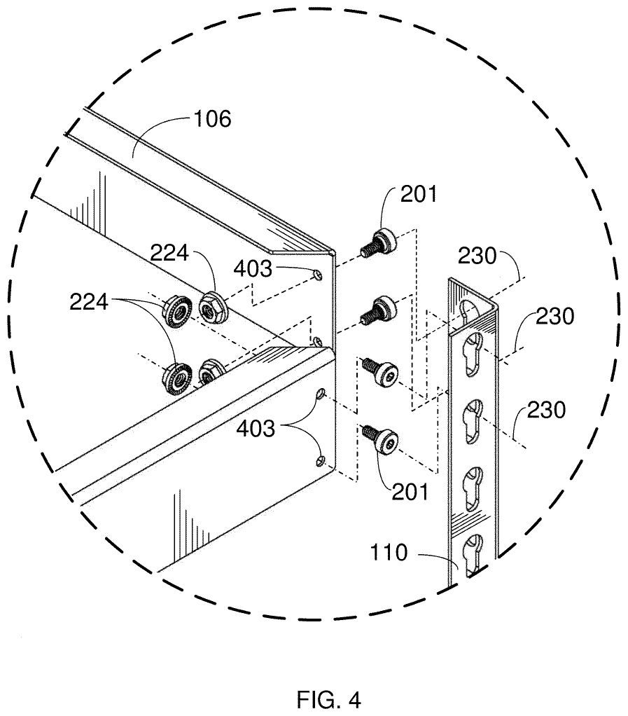

FIG. 4 is an enlarged view of a portion of FIG. 3 as indicated in the broken line circle 320 in FIG. 3. As discussed above, vertical post 110 is generally L-shaped with two flat faces 702, 704 that lie perpendicular to one another. Each face 702, 704 includes a plurality of vertically spaced keyhole-shaped openings 202, each having a wider upper portion 204 and a lower narrow portion 206 that are dimensioned to capture the heads of the shoulder bolts or similar fasteners discussed herein. In some embodiments the vertically spaced openings extend over the entire length of the vertical posts, which allows the heights of the shelves to be adjusted to various heights. Beams 106 are formed with mounting holes 403 at each end of the beam, which allow the beams to be attached to and supported by vertical posts 110. In the embodiment of FIG. 2, the spacing between the two mounting holes at an end of the beam is substantially the same as the vertical spacing between keyhole slots 202 vertical post 110.

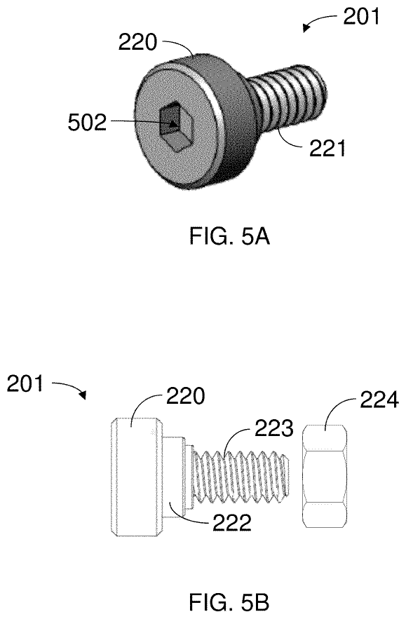

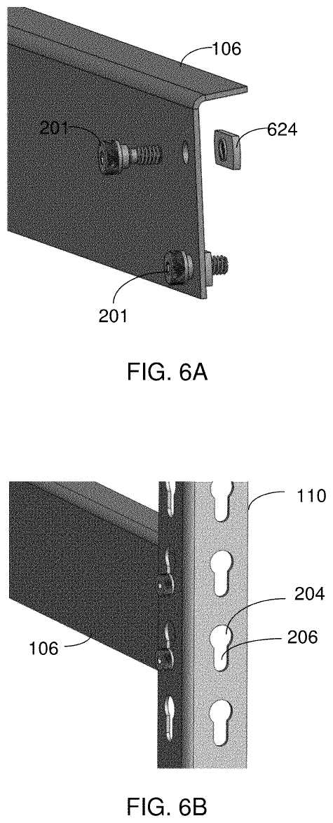

In embodiments, beams 106 maybe attached to vertical posts 110 using shoulder bolts 201. Referring also to FIGS. 5A-5B, shoulder bolts 201 include a head portion 220 and a narrower shank portion 221, which has an unthreaded shoulder portion 222, a second shoulder portion 222b, and a threaded portion 223. As shown by dashed lines 230, the shank portion 221 of each shoulder bolt 201 may be inserted through one of the mounting holes 403 so that the threaded portion of the shank 221 extends to the inside of the beam 106, with the head portion 220 facing out (toward the outer face of the beam in its assembled orientation). Shoulder bolts 201 maybe held in place by hex nuts 224 or other suitable attachment means (such as, for example, the square nut 624 shown in the embodiment of FIG. 6A, or other known types of nuts, clips, or pins) adapted to engage the shank portion 221 of the shoulder bolts. Nuts 224 and/or shoulder bolt heads 220 may be formed with a wrench/tool receiving surface to allow the bolts to be tightened or loosened. For example, one or both of the nuts 224 and bolt head 220 may be hex shaped so that an ordinary wrench may be used to tighten or loosen the bolt. Other types of wrench/tool receiving surfaces could be used such as the hexagonal socket 502 in the bolt head shown in FIG. 5A, which allows the bolt to be tightened or loosened using an appropriately sized hex key.

Once shoulder bolts 201 have been mounted onto the end of beam 106, the head portions 220 of the two shoulder bolts 201 maybe inserted into the wide portions 204 of corresponding keyhole slots on vertical post 110 (depending on the desired vertical position of the shelf or deck to be supported). The beam may then be push downward with respect to the vertical post and keyhole slot so that the narrower unthreaded shoulder portion of the bolt will slide into the lower portion 206 of the keyhole slot. Because the slots are dimensioned so that the head portions are too large to fit through the lower portion of the keyhole slots, the beams and vertical posts maybe held securely together. In order to detach the beams from the posts, the beam must be lifted up so that the bolt heads maybe withdrawn through the wider upper portions of the keyhole slots.

Significantly, the shoulder bolts in embodiments are not permanently attached to the beams like the rivets of known boltless shelving units. This provides a number of significant advantages. By only loosely tightening the shoulder bolts and nuts when they are initially mounted onto the beams 106, the heads and shoulder portions of the bolts may easily slide into the keyhole slots without the application of any significant force (such as by using a hammer to seat the bolts in the keyhole slots). Then once the beams and vertical posts are assembled by sliding the shoulder bolt heads (mounted onto the beams) into the keyhole slots on the vertical supports, a wrench or other tool maybe used to tighten the shoulder bolts 201 in order to apply compressive force to the connected portions of the beams and vertical supports to lock those connections in place. In order to disassemble shelving according to embodiments, shoulder bolts 201 may be loosened using the same wrench or other tool so that the bolt heads may be easily removed from the keyhole slots. Shoulder bolts according to embodiments may, for example, be easily removed from the beams and replaced in the event that one or more bolts becomes damaged or otherwise unusable.

In some embodiments, the length of the unthreaded shoulder portion 222 is approximately equal to the total thickness of the mounting surface of beam 106 and the thickness of the vertical support post. In other embodiments, the length of the unthreaded shoulder portion 222 is shorter than the total thickness of the mounting surface of beam 106 and the thickness of the vertical support post, which allows for the application of a very high degree of compressive force to hold the beams in place.

As depicted, the second shoulder portion of the unthreaded portion 222 may, for example, be used to center and locate the shoulder bolt on the crossbeam. The secondary shoulder may, for example, be used to prevent any minor movement in the completed assembly The secondary shoulder may, for example, prevent unwanted movement caused by the difference in the diameter between the threaded shank and the hole opening in the cross beam.

The secondary shoulder may, for example, be designed for a tight fit. The secondary shoulder fit may, for example, be tighter than a configuration where the threaded shank fits tightly in the hole opening of the crossbeam.

The secondary shoulder may, for example, keep the bolt centered in the hole of the cross beam. The configuration of the second shoulder may, for example, advantageously reduce play in the final assembly.

The shoulder bolt may, for example, be a rivet replacement. The nut may, for example, provide an aesthetic and structural component to enhance the assembly. The squared shoulder may, for example, be used to remove the requirement for a tool.

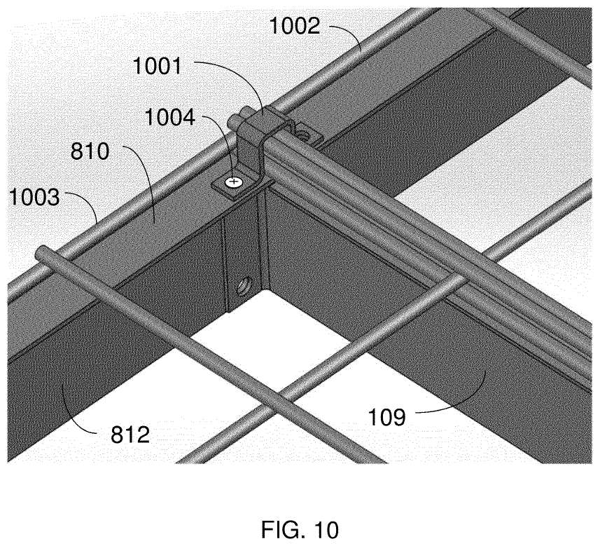

In some embodiments, multiple welded wire deck sections or panels may be combined to create a larger wire deck. While generally rectangular decks have been described, the embodiments are not limited to any particular shape of deck. As shown in the embodiment of FIG. 10, a clip 1001 that maybe used to hold two deck panels 1002, 1003 in place on the support beams. Clip 1001 maybe placed over the end wires of adjacent wire decks and attached to the horizontal portion 810 of the support beam using any suitable type of fastener 1004 such as typical screw or bolt and nut fasteners. In some embodiments, the joint between the two adjacent deck panels 1002, 1003 maybe supported by a center support 109 for increased strength.

FIG. 10 is a view of a clip used to hold two deck panels in place on the support beams according to an embodiment.

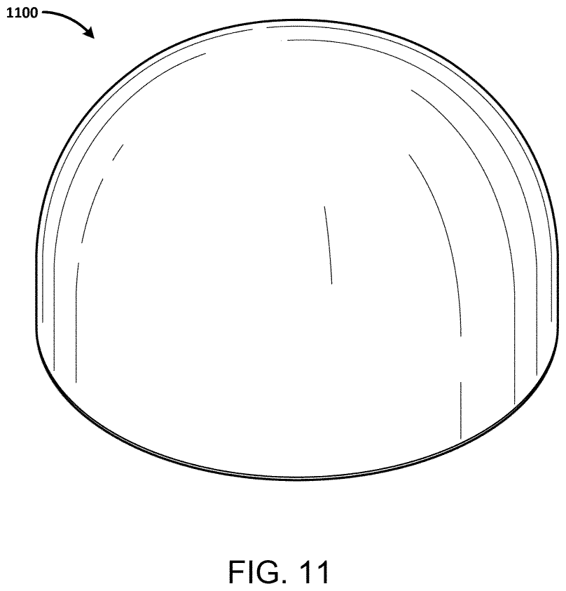

FIGS. 11-14 depict illustrative embodiments related to a threaded rivet replacement, and shelving units assembled by a threaded rivet replacement. For example, some embodiments include a nut and a bolt. The nut and/or the bolt head may, for example, lack a drive feature (e.g., Phillips drive, square drive, hex drive). For example, the head may be smooth.

In some implementations, the head may be low-profile (e.g., flat), such as a ‘pancake head’. In some implementations, the head may be rounded.

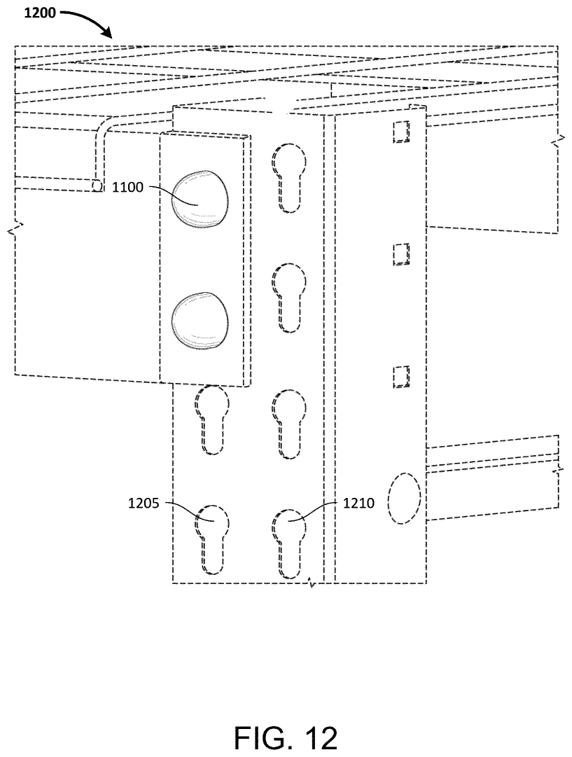

FIG. 11 depicts a domed-shaped carriage nut 1100. The dome-shaped carriage nut may, for example, include a rivet and nut assembly. FIG. 12 depicts front view of a domed-shaped carriage nut 1100 used in a shelving unit 1200. The shelving unit 1200 includes the first set of keyholes 1205. The shelving unit 1200 includes a second set of keyholes 1210. The adjacent set of key holes may, for example, allow a user to couple two adjacent shelving units together. A user may, for example, couple the two adjacent shelving units together with the dome shaped carriage nut.

In some embodiments, such as embodiments with a head (e.g., nut and/or bolt) not including an accessible drive feature (e.g., smooth head), a hidden drive feature may, for example, be included. For example, a hidden drive feature on the head may engage a corresponding feature (e.g., on the shelving) to resist rotation of the head during assembly of the threaded rivet replacement.

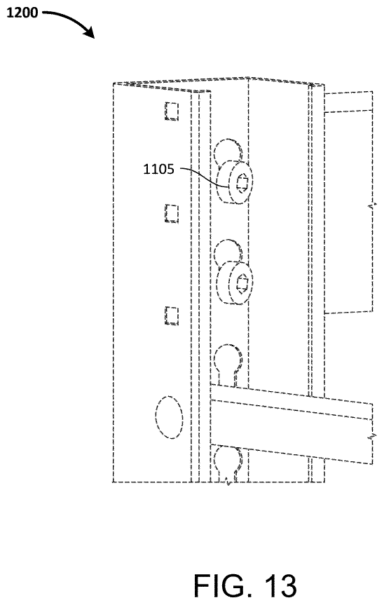

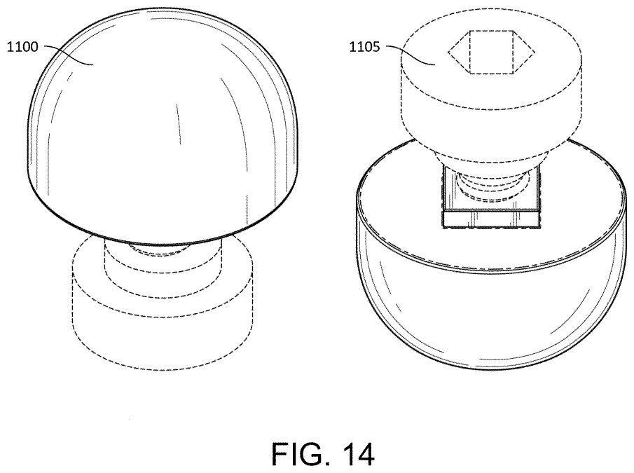

FIG. 13 depicts a rear view of a domed-shaped carriage nut used in a shelving unit. The domed-shape carriage nut is coupled to the shelving unit by a fastener 1105. FIG. 14 depicts a front and rear perspective view of an exemplary dome-shaped carriage nut 1100. FIG. 14 depicts the fastener 1105.

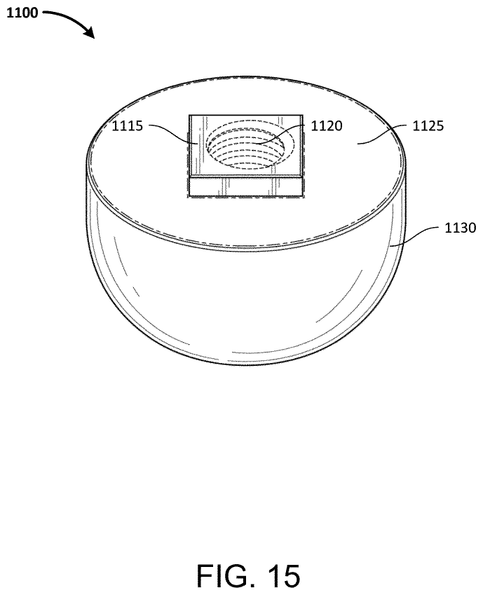

FIG. 15 depicts a rear view of an exemplary dome-shaped carriage nut 1100. The dome-shaped carriage nut 1100 includes a square region 1115 (e.g., a hidden drive feature). The square region includes a threaded portion 1120. The rear of the dome shaped carriage nut 1100 includes a flat region 1125. The front of the rear of the dome shaped carriage nut includes a domed region 1130. The square shoulder may, for example, provide a structural method of preventing movement or rotation during installation.

Although a square drive feature is depicted, other features are possible. For example, some features may be elliptical. Some embodiments may, for example, include polygonal (e.g., hexagonal, octagonal, triangular) drive features. Some embodiments may, for example, include a flat (e.g., blade-like) drive feature.

In some embodiments, the head may be solid (e.g., as shown). In some implementations, the head may be at least partially hollow. In some implementations, for example, the head may include an open (e.g., truss-type) structure.

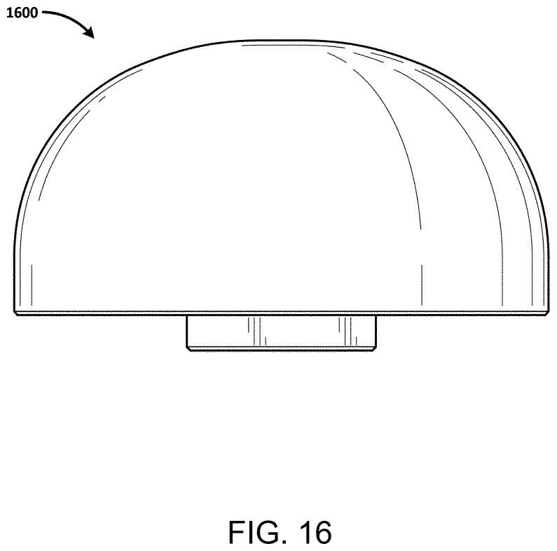

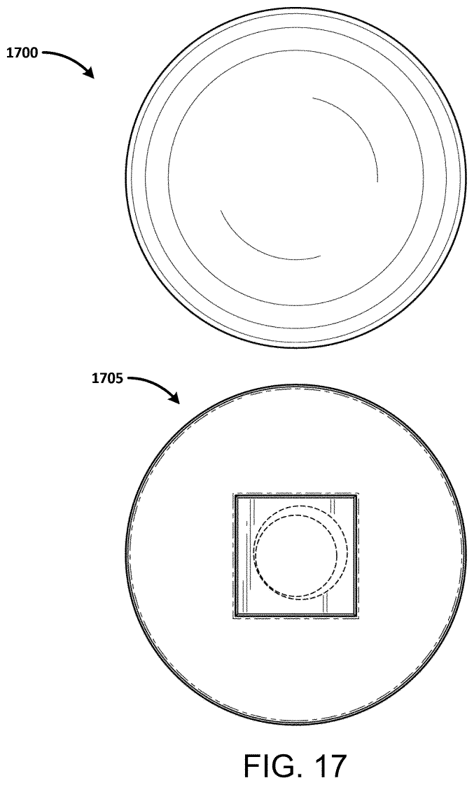

FIG. 16 depicts a side view of an exemplary dome-shaped carriage nut 1600. FIG. 17 depicts a top view 1700 and a bottom view 1705 of an exemplary dome shaped carriage nut.

Various embodiments may advantageously provide a threaded assembly replacement for a rivet. For example, some embodiments may advantageously provide a replacement for rivet fasteners that only require readily available tools (e.g., without the need for manual, electric, pneumatic, and/or hydraulic rivet setting tools).

In some implementations, the threaded assembly may be pre-coupled to form a single rivet replacement. For example, the bolt and nut may be assembled together (e.g., on beams 106). The bolt may, for example, have one or more shoulder (as disclosed at least with reference to shoulder bolt 201). The shoulder may, for example, provide a spacing between the nut and the bolt head. In some implementations, for example, the pre-assembled bolt and nut may advantageously enable rapid assembly of shelving (e.g., during installation).

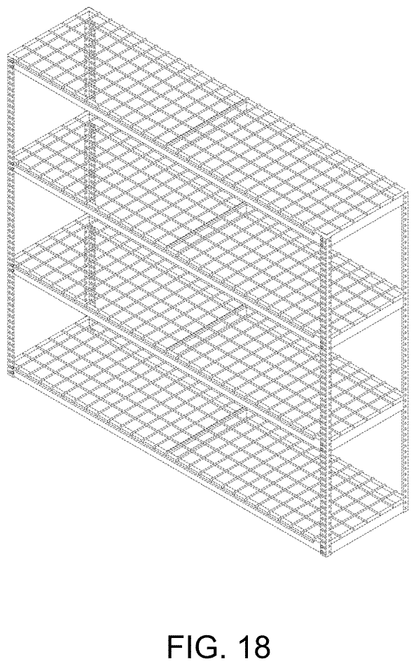

FIG. 18 depicts an exemplary shelving including a double keyhole pattern & dome shaped carriage nut configuration. As depicted, one side may have a double keyhole embodiment pattern, and an adjacent second side having a single square embodiment pattern. In some embodiments, one side may have a double keyhole embodiment pattern, and the adjacent second side may have a single keyhole embodiment pattern. In some embodiments, the adjacent side may, for example, have multiple sets of keyholes patterns. The double keyhole embodiments may, for example, allow a user to couple two shelves together. A user may couple the two shelves together using the dome shaped rivet.

The embodiments described herein have broad applicability and may provide many benefits as described and shown in the examples above. The embodiments will vary greatly depending upon the specific application. In some embodiments, for example, the arrangement of shoulder bolts and keyhole slots could be reversed so that the keyhole slots are formed on the horizontal beams and the shoulder bolts are attached to the vertical corner posts. Not every embodiment will provide all the benefits and meet all the objectives that are achievable by the embodiments.

In the discussion and in the claims, the terms “including” and “comprising” are used in an open-ended fashion, and thus should be interpreted to mean “including, but not limited to . . . ” To the extent that any term is not specially defined in this specification, the intent is that the term is to be given its plain and ordinary meaning. The accompanying drawings are intended to aid in understanding the present embodiments and, unless otherwise indicated, are not drawn to scale. As used herein, the words “right,” “left,” “lower,” “upper,” “bottom,” “horizontal,” “vertical,” “outer,” “inner,” and the like designate directions in the drawings to which reference is made. These terms are used for convenience only and are not limiting.

A number of implementations have been described. Nevertheless, it will be understood that various modifications may be made. For example, advantageous results may be achieved if the steps of the disclosed techniques were performed in a different sequence, or if components of the disclosed systems were combined in a different manner, or if the components were supplemented with other components. Accordingly, other implementations are contemplated within the scope of the following claims.

What is claimed is:

1. A shelving unit comprising:
a deck configured to store items;
a frame configured to support the deck along at least a portion of a perimeter of the deck, the frame comprising:
two or more beams, each of the beams comprising an opening at each end of the beam configured to receive a fastener;
fasteners configured to fasten the opening at the end of each of the beams forming the frame, the fasteners comprising:
shoulder bolts, each shoulder bolt having a head and a shank, with the shank having a threaded portion distal to the head and an unthreaded portion proximal to the head, the unthreaded portion having a substantially smooth surface; and,
nuts comprising a drive-less surface and an opposing surface comprising a drive element; and,
multiple vertical posts configured to support the beams, each of the multiple vertical posts including a plurality of generally keyhole shaped openings;
wherein:
the fasteners are each directly attached to the beams by inserting the fastener shank through a corresponding at least one of the openings at the end of the beam and tightening a corresponding one of the nuts on the threaded portion of the shank such that: the drive element engages the at least one of the openings and is concealed by the beam, and the drive-less surface is visible, and
the beams are attached to the vertical posts by inserting the shoulder bolt head into one of the keyhole shaped openings in the vertical posts.

2. The shelving unit of claim 1 in which the shoulder bolt head has a lateral dimension that is greater than the lateral dimension of the shoulder bolt shank.

3. The shelving unit of claim 2 in which the generally keyhole shaped openings have a wider upper portion and a narrower lower portion extending downward from the upper portion.

4. The shelving unit of claim 2 in which the generally keyhole shaped openings have a larger upper opening sized so that it is large enough to receive the head of said shoulder bolt and a narrower lower opening extending downward from the upper opening, said lower opening being sufficiently wide to receive the shank of the shoulder bolt but not large enough to allow passage of the head of the shoulder bolt.

5. The shelving unit of claim 1 in which the head of the shoulder bolt is formed with a tool receiving surface so that said bolt can be further tightened after the frame is attached to the vertical posts to apply compressive force to hold the frame in place.

6. The shelving unit of claim 1 in which the head of the shoulder bolt is formed with a fastener pattern so that the shoulder bolt can be tightened using a operable fastener driver.

7. The shelving unit of claim 1 in which the length of the unthreaded portion is approximately equal to the combined thickness of the beam and the vertical posts.

8. The shelving unit of claim 1 in which the length of the unthreaded portion is shorter than the combined thickness of the beam and the vertical post.

9. The shelving unit of claim 1 in which the deck comprises a welded wire mesh.

10. The shelving unit of claim 1 in which the deck comprises two or more deck panels mounted side-by-side.

11. The shelving unit of claim 1 in which the frame for supporting the deck comprises two longitudinal beams and two transverse beams forming a rectangular frame supporting the deck along an entire perimeter of the deck.

12. The shelving unit of claim 1, in which the frame for supporting the deck comprises one or more center support beams extending across the center of the deck between two horizontal support beams.

13. The shelving unit of claim 1, in which the beams comprise a shaped cross section comprising a vertical portion and a horizontal portion, said horizontal portion serving to support the deck.

14. A shelving unit comprising:
a deck configured to store at least one item;
a frame configured to support the deck along at least a portion of a perimeter of the deck, the frame comprising:
two or more horizontal support beams; and,
multiple vertical posts for supporting the beams; and,
fasteners configured to couple the end of each of the beams forming the frame to the multiple vertical posts, the fasteners comprising:
shoulder bolts, each shoulder bolt having a head and a shank narrower than the head, with the shank having a threaded portion distal to the head and an unthreaded portion proximal to the head, the unthreaded portion having a substantially smooth surface; and,
caps, each cap comprising a drive-less surface and, an opposing surface comprising a drive element enveloping an aperture including a threaded cavity configured to receive the threaded portion,
wherein:
the frame is attached to each of the multiple vertical posts by way of shoulder bolts at each end of each of the two or more beams,
each of the shoulder bolts being attached to the beams by a corresponding one of the nuts threaded onto the threaded portion of the shank such that:
the drive element is brought into register with, engages, and is obscured by a corresponding aperture in the beam, and the drive-less surface extends visibly away from the beam, and
the head and the unthreaded portion of the shank extend from an outer face of the beam so that the head is configured to then be inserted into one of a plurality of keyhole shaped openings in the vertical posts, and
each of the plurality of keyhole shaped openings having a wider upper portion and a narrower lower portion, the keyhole shaped opening sized so that the upper portion is large enough to receive a head portion of one of the shoulder bolts, while the lower narrow portion is sufficiently wide to receive the shank of the shoulder bolt or similar fastener but not large enough to allow passage of the head.

15. The shelving unit of claim 14, wherein the fasteners are directly attached to the beams by inserting the fastener shank through the openings at the end of the beam and tightening a nut on the threaded portion of the shank.

16. The shelving unit of claim 14 in which the head of the shoulder bolt is formed with a tool receiving surface so that said bolt can be further tightened after the frame is attached to the vertical posts to apply compressive force to hold the frame in place.

17. The shelving unit of claim 14 in which the length of the unthreaded portion of the shank of the shoulder bolts is approximately equal to the combined thickness of the beam and the vertical posts.

18. The shelving unit of claim 14 in which the deck comprises a welded wire mesh.

19. The shelving unit of claim 14 in which the frame for supporting the deck comprises two longitudinal beams and two transverse beams forming a rectangular frame supporting the deck along an entire perimeter of the deck.

20. The shelving unit of claim 14 in which the deck comprises two or more deck panels mounted side-by-side.
